(19) United States
(12) Patent Application Publication
(10) Pub. No.: US 2013/0344944 A1
(43) Pub. Date: Dec. 26, 2013

(54) ELECTRONIC METHOD OF GAMING, A GAME CONTROLLER AND A GAMING SYSTEM

(71) Applicant: Aristocrat Technologies Australia Pty Limited, North Ryde (AU)

(72) Inventor: Matthew Chan, East Killara (AU)

(21) Appl. No.: 13/928,071

(22) Filed: Jun. 26, 2013

(30) Foreign Application Priority Data
Jun. 26, 2012 (AU) 2012902710

(51) Int. Cl. G07F 17/32

(52) U.S. Cl. CPC G07F 17/3244
USPC 463/25

(57) ABSTRACT

Certain examples provide electronic gaming systems and methods. An example electronic method of gaming comprising conducting a base game portion of a game by selecting a plurality of symbols for display at a plurality of symbol positions on a display; evaluating the selected symbols to determine whether a trigger condition has been met for a feature game portion of the game to be conducted, the trigger condition comprising the occurrence of a defined combination of trigger symbols amongst the selected symbols; upon the trigger condition being met, independently determining, for each trigger symbol of the combination of trigger symbols, a number of game events to be awarded from at least two different numbers of game events to thereby determine a total number of game events to be awarded for the feature game portion of the game; and conducting the feature game based on the total number of game events awarded.

### CROSS-REFERENCE TO RELATED APPLICATIONS

The present application claims the benefit of priority to Australian Provisional Patent Application No. 2012902710, filed on Jun. 26, 2012, entitled “AN ELECTRONIC METHOD OF GAMING, A GAME CONTROLLER AND A GAMING SYSTEM”, which is herein incorporated by reference in its entirety.

### FIELD

The invention relates to an electronic method of gaming, a game controller and a gaming system.

### BACKGROUND

Some gaming systems, such as electronic gaming machines, provide spinning reel games where a when a trigger condition is met a feature game is awarded comprising, for example, a series of “free games” where the reels are re-spun without the player making a further wager.

While such gaming systems provide players with enjoyment, a need exists for alternative gaming systems in order to maintain or increase player enjoyment.

### SUMMARY

In a first aspect, the invention provides an electronic method of gaming including:

conducting a base game portion of a game by selecting a plurality of symbols for display at a plurality of symbol positions on a display;

evaluating the selected symbols to determine whether a trigger condition has been met for a feature game portion of the game to be conducted, the trigger condition including the occurrence of a defined combination of trigger symbols amongst the selected symbols;

upon the trigger condition being met, independently determining, for each trigger symbol of the combination of trigger symbols, a number of game events to be awarded from at least two different numbers of game events to thereby determine a total number of game events to be awarded for the feature game portion of the game; and

conducting the feature game based on the total number of game events awarded.

In an embodiment, the method includes determining the number of game events includes selecting a number from a set of possible numbers of game events for each individual trigger symbol.

In an embodiment, each game event includes a game round to be conducted in the feature game.

In an embodiment, the method includes adding to the number of game rounds conducted in the feature game in response to an extension condition being met in respect of a game round in the feature game.

In an embodiment, the extension condition includes an improvement to a winning combination in the game round.

In a second aspect, the invention provides a gaming system including:

a display;

a symbol selector arranged to selecting a plurality of symbols for display at a plurality of symbol positions on the display as part of a base game portion of a game conducted by the gaming system;

a trigger monitor arranged to evaluating the selected symbols to determine whether a trigger condition has been met for a feature game portion of the game to be conducted, the trigger condition including the occurrence of a defined combination of trigger symbols amongst the selected symbols; and

a game round determiner arranged to independently determine for each trigger symbol of a combination of trigger symbols evaluated as meeting the trigger condition, a number of game events to be awarded from at least two different numbers of game events to thereby determine a total number of game events to be awarded for the feature game portion of the game,

the gaming system arranged to conduct the feature game based on the total number of game events awarded.

In an embodiment, the game round determiner determines the number of game events by selecting a number from a set of possible numbers of game events for each individual trigger symbol.

In an embodiment, each game event includes a game round to be conducted in the feature game.

In an embodiment, the gaming system is arranged to add to the number of game rounds conducted in the feature game in response to an extension condition being met in respect of a game round in the feature game.

In an embodiment, the extension condition includes an improvement to a winning combination in the game round.

In a third aspect, the invention provides a game controller for a gaming system, the game controller arranged to:

conduct a base game portion of a game by selecting a plurality of symbols for display at a plurality of symbol positions on a display;

evaluate the selected symbols to determine whether a trigger condition has been met for a feature game portion of the game to be conducted, the trigger condition including the occurrence of a defined combination of trigger symbols amongst the selected symbols;

upon the trigger condition being met, independently determine, for each trigger symbol of the combination of trigger symbols, a number of game events to be awarded from at least two different numbers of game events to thereby determine a total number of game events to be awarded for the feature game portion of the game; and

conduct the feature game based on the total number of game events awarded.

In an embodiment, the game controller is arranged to determine the number of game events by selecting a number from a set of possible numbers of game events for each individual trigger symbol.

In an embodiment, each game event includes a game round to be conducted in the feature game.

In an embodiment, the game controller is arranged to add to the number of game rounds conducted in the feature game in response to an extension condition being met in respect of a game round in the feature game.

In an embodiment, the extension condition includes an improvement to a winning combination in the game round.

In a fourth aspect, the invention provides an electronic method of gaming including:

initiating a series of game rounds based on initial designated symbols and an initial number of game rounds to be conducted with each designated symbol displayed at a symbol display position of a plurality of symbol display positions at which the designated symbol is to be held throughout the series of game rounds;

conducting each game round by selecting symbols for display at symbol display positions other than symbol display positions at which designated symbols are held;

upon one or more designated symbols being selected in a game round of the series, extending the series of game rounds by at least one game round and adding the one or more designated symbols to the designated symbols held at symbol display positions in subsequent game rounds; and

making an award at the conclusion of the series of game rounds based on the displayed designated symbols.

In an embodiment, the method includes extending the series of game rounds by one game.

In an embodiment, the method includes terminating the series of game rounds upon a maximum number of designated symbols being reached.

In a fifth aspect, the invention provides a gaming system including:

a display; and

a game controller arranged to:
initiate a series of game rounds based on initial designated symbols and an initial number of game rounds to be conducted with each designated symbol displayed at a symbol display position of a plurality of symbol display positions at which the designated symbol is to be held throughout the series of game rounds;
conduct each game round by selecting symbols for display at symbol display positions other than symbol display positions at which designated symbols are held;
upon one or more designated symbols being selected in a game round of the series, extend the series of game rounds by at least one game round and adding the one or more designated symbols to the designated symbols held at symbol display positions in subsequent game rounds; and
make an award at the conclusion of the series of game rounds based on the displayed designated symbols.

In an embodiment, the gaming system is arranged to extend the series of game rounds by one game.

In an embodiment, the gaming system is arranged to terminate the series of game rounds upon a maximum number of designated symbols being reached.

In a sixth aspect, the invention provides a game controller for a gaming system, the game controller arranged to:

initiate a series of game rounds based on initial designated symbols and an initial number of game rounds to be conducted with each designated symbol displayed at a symbol display position of a plurality of symbol display positions at which the designated symbol is to be held throughout the series of game rounds;

conduct each game round by selecting symbols for display at symbol display positions other than symbol display positions at which designated symbols are held;

upon one or more designated symbols being selected in a game round of the series, extend the series of game rounds by at least one game round and adding the one or more designated symbols to the designated symbols held at symbol display positions in subsequent game rounds; and

make an award at the conclusion of the series of game rounds based on the displayed designated symbols.

In an embodiment, the game controller is arranged to extend the series of game rounds by one game.

In an embodiment, the game controller is arranged to terminate the series of game rounds upon a maximum number of designated symbols being reached.

In a seventh aspect, the invention provides computer program code which when executed implements the above method.

In an eighth aspect, the invention provides a tangible computer readable medium including the above program code.

### BRIEF DESCRIPTION OF THE DRAWINGS

Exemplary embodiments of the invention will now be described, by way of example only, with reference to the accompanying drawings in which:

FIG. 1 is a block diagram of the core components of a gaming system;

FIG. 2 is a perspective view of a standalone gaming machine;

FIG. 3 is a block diagram of the functional components of a gaming machine;

FIG. 4 is a schematic diagram of the functional components of a memory;

FIG. 5 is a schematic diagram of a network gaming system;

FIG. 6 is a further block diagram of a gaming system; and

FIG. 7 is a flow chart of an embodiment.

In addition, the drawings are for the purpose of illustrating example embodiments, but it is understood that the present disclosure is not limited to the arrangements and instrumentality shown in the drawings.

### DETAILED DESCRIPTION

Although the following discloses example methods, systems, articles of manufacture, and apparatus including, among other components, software executed on hardware, it should be noted that such methods and apparatus are merely illustrative and should not be considered as limiting. For example, it is contemplated that any or all of these hardware and software components could be embodied exclusively in hardware, exclusively in software, exclusively in firmware, or in any combination of hardware, software, and/or firmware. Accordingly, while the following describes example methods, systems, articles of manufacture, and apparatus, the examples provided are not the only way to implement such methods, systems, articles of manufacture, and apparatus.

When any of the appended claims are read to cover a purely software and/or firmware implementation, in at least one embodiment, at least one of the elements is hereby expressly defined to include a tangible medium such as a memory, DVD, CD, Blu-Ray, etc., storing the software and/or firmware.

These embodiments and many additional embodiments are described more below. Further, the detailed description is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain embodiments of the present disclosure may be practiced without certain, specific details. In other instances, well known methods, procedures, components, and circuitry have not been described in detail to avoid unnecessarily obscuring aspects of the embodiments.

Reference herein to “embodiment” means that a particular feature, structure, or characteristic described in connection with the embodiment can be included in at least one example embodiment of the invention. The appearances of this phrase in various places in the specification are not necessarily all referring to the same embodiment, nor are separate or alternative embodiments mutually exclusive of other embodiments. As such, the embodiments described herein, explicitly and implicitly understood by one skilled in the art, may be combined with other embodiments.

Referring to the drawings, there is shown a gaming system having a game controller arranged to electronically implement a game where upon a trigger condition being met an evaluation is conducted to determine how many game events are to be awarded. The trigger condition is a defined combination of trigger symbols. The evaluation is performed by independently determining for each trigger symbol, a number of game events to be awarded.

In an advantageous embodiment, the game events are game rounds and the awarded number of game rounds sets an initial number of game rounds to be conducted based on initial designated symbols. During each game round symbols are selected for all symbol positions except where designated symbols have already been selected (or specified by the initial designated symbols). When a designated symbol is selected, the series of game rounds is extended by at least one game round and the designated symbol is added to those held in position for subsequent game rounds. At the conclusion of the game rounds, an award is made based on the displayed designated symbols.

### General Construction of Gaming System

The gaming system can take a number of different forms. In a first form, a stand alone gaming machine is provided wherein all or most components to implement the game are present in a player operable gaming machine.

In a second form, a distributed architecture is provided wherein some of the components to implement the game are present in a player operable gaming machine and some of the components to implement the game are located remotely relative to the gaming machine. For example, a “thick client” architecture may be used wherein part of the game is executed on a player operable gaming machine and part of the game is executed remotely, such as by a gaming server; or a “thin client” architecture may be used wherein most of the game is executed remotely such as by a gaming server and a player operable gaming machine is used only to display audible and/or visible gaming information to the player and receive gaming inputs from the player.

However, it will be understood that other arrangements are envisaged. For example, an architecture may be provided wherein a gaming machine is networked to a gaming server and the respective functions of the gaming machine and the gaming server are selectively modifiable. For example, the gaming system may operate in standalone gaming machine mode, “thick client” mode or “thin client” mode depending on the game being played, operating conditions, and so on. Other variations will be apparent to persons skilled in the art.

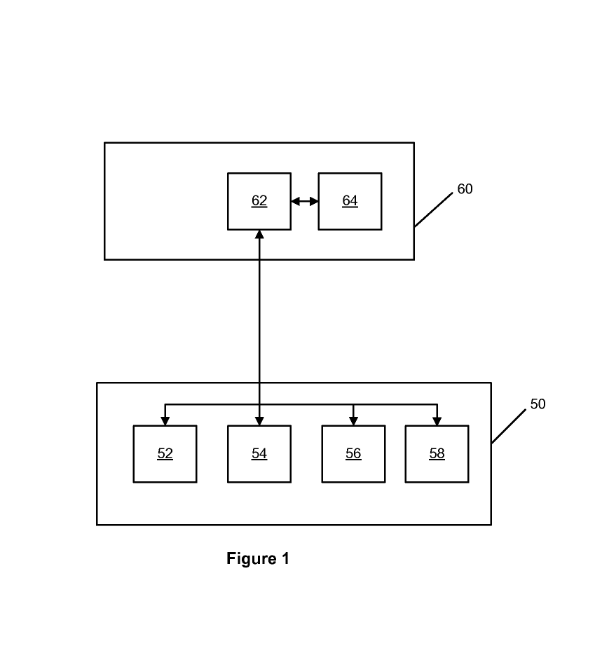

Irrespective of the form, the gaming system has several core components. At the broadest level, the core components are a player interface 50 and a game controller 60 as illustrated in FIG. 1. The player interface is arranged to enable manual interaction between a player and the gaming system and for this purpose includes the input/output components for the player to enter instructions to play the game and observe the game outcomes.

Components of the player interface may vary from embodiment to embodiment but will typically include a credit mechanism 52 to enable a player to input credits and receive payouts, one or more displays 54, a game play mechanism 56 including one or more input devices that enable a player to input game play instructions (e.g. to place a wager), and one or more speakers 58.

The game controller 60 is in data communication with the player interface and typically includes a processor 62 that processes the game play instructions in accordance with game play rules and outputs game play outcomes to the display. Typically, the game play rules are stored as program code in a memory 64 but can also be hardwired. Herein the term “processor” is used to refer generically to any device that can process game play instructions in accordance with game play rules and may include: a microprocessor, microcontroller, programmable logic device or other computational device, a general purpose computer (e.g. a PC) or a server. That is a processor may be provided by any suitable logic circuitry for receiving inputs, processing them in accordance with instructions stored in memory and generating outputs (for example on the display). Such processors are sometimes also referred to as central processing units (CPUs). Most processors are general purpose units, however, it is also know to provide a specific purpose processor using an application specific integrated circuit (ASIC) or a field programmable gate array (FPGA).

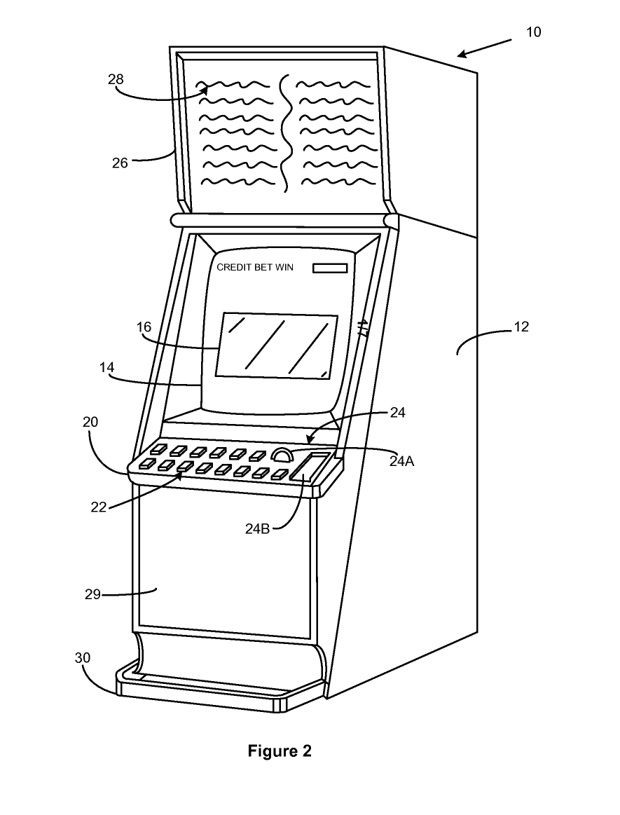

A gaming system in the form of a stand alone gaming machine 10 is illustrated in FIG. 2. The gaming machine 10 includes a console 12 having a display 14 on which are displayed representations of a game 16 that can be played by a player. A mid-trim 20 of the gaming machine 10 houses a bank of buttons 22 for enabling a player to interact with the gaming machine, in particular during game play. The mid-trim 20 also houses a credit input mechanism 24 which in this example includes a coin input chute 24A and a bill collector 24B. Other credit input mechanisms may also be employed, for example, a card reader for reading a smart card, debit card or credit card. Other gaming machines may configure for ticket in such that they have a ticket reader for reading tickets having a value and crediting the player based on the face value of the ticker. A player marketing module (not shown) having a reading device may also be provided for the purpose of reading a player tracking device, for example as part of a loyalty program. The player tracking device may be in the form of a card, flash drive or any other portable storage medium capable of being read by the reading device. In some embodiments, the player marketing module may provide an additional credit mechanism, either by transferring credits to the gaming machine from credits stored on the player tracking device or by transferring credits from a player account in data communication with the player marketing module.

A top box 26 may carry artwork 28, including for example pay tables and details of bonus awards and other information or images relating to the game. Further artwork and/or information may be provided on a front panel 29 of the console 12. A coin tray 30 is mounted beneath the front panel 29 for dispensing cash payouts from the gaming machine 10.

The display 14 shown in FIG. 2 is in the form of a video display unit, particularly a cathode ray tube screen device. Alternatively, the display 14 may be a liquid crystal display, plasma screen, any other suitable video display unit, or the visible portion of an electromechanical device. The top box 26 may also include a display, for example a video display unit, which may be of the same type as the display 14, or of a different type.

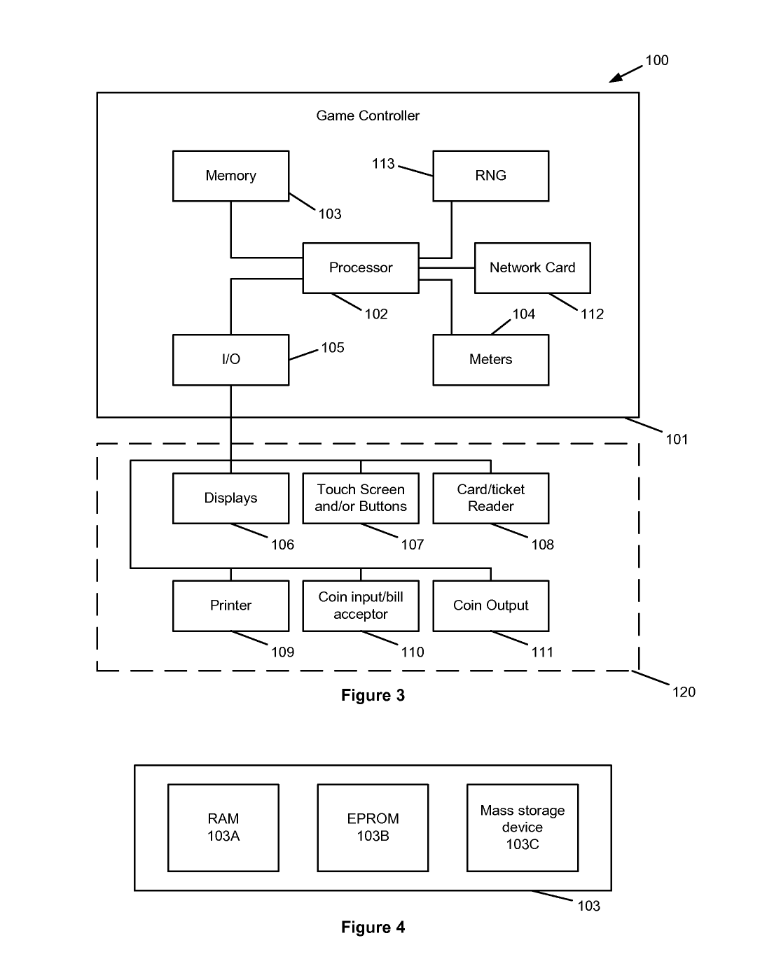

FIG. 3 shows a block diagram of operative components of a typical gaming machine which may be the same as or different to the gaming machine of FIG. 2.

The gaming machine 100 includes a game controller 101 having a processor 102 mounted on a circuit board. Instructions and data to control operation of the processor 102 are stored in a memory 103, which is in data communication with the processor 102. Typically, the gaming machine 100 will include both volatile and non-volatile memory and more than one of each type of memory, with such memories being collectively represented by the memory 103.

The gaming machine has hardware meters 104 for purposes including ensuring regulatory compliance and monitoring player credit, an input/output (I/O) interface 105 for communicating with peripheral devices of the gaming machine 100. The input/output interface 105 and/or the peripheral devices may be intelligent devices with their own memory for storing associated instructions and data for use with the input/output interface or the peripheral devices. A random number generator module 113 generates random numbers for use by the processor 102. Persons skilled in the art will appreciate that the reference to random numbers includes pseudo-random numbers.

In the example shown in FIG. 3, a player interface 120 includes peripheral devices that communicate with the game controller 101 including one or more displays 106, a touch screen and/or buttons 107 (which provide a game play mechanism), a card and/or ticket reader 108, a printer 109, a bill acceptor and/or coin input mechanism 110 and a coin output mechanism 111. Additional hardware may be included as part of the gaming machine 100, or hardware may be omitted based on the specific implementation. For example, while buttons or touch screens are typically used in gaming machines to allow a player to place a wager and initiate a play of a game any input device that enables the player to input game play instructions may be used. For example, in some gaming machines a mechanical handle is used to initiate a play of the game. Persons skilled in the art will also appreciate that a touch screen can be used to emulate other input devices, for example, a touch screen can display virtual buttons which a player can “press” by touching the screen where they are displayed.

In addition, the gaming machine 100 may include a communications interface, for example a network card 112. The network card may, for example, send status information, accounting information or other information to a bonus controller, central controller, server or database and receive data or commands from the bonus controller, central controller, server or database. In embodiments employing a player marketing module, communications over a network may be via player marketing module—i.e. the player marketing module may be in data communication with one or more of the above devices and communicate with it on behalf of the gaming machine.

FIG. 4 shows a block diagram of the main components of an exemplary memory 103. The memory 103 includes RAM 103A, EPROM 103B and a mass storage device 103C. The RAM 103A typically temporarily holds program files for execution by the processor 102 and related data. The EPROM 103B may be a boot ROM device and/or may contain some system or game related code. The mass storage device 103C is typically used to store game programs, the integrity of which may be verified and/or authenticated by the processor 102 using protected code from the EPROM 103B or elsewhere.

It is also possible for the operative components of the gaming machine 100 to be distributed, for example input/output devices 106,107,108,109,110,111 to be provided remotely from the game controller 101.

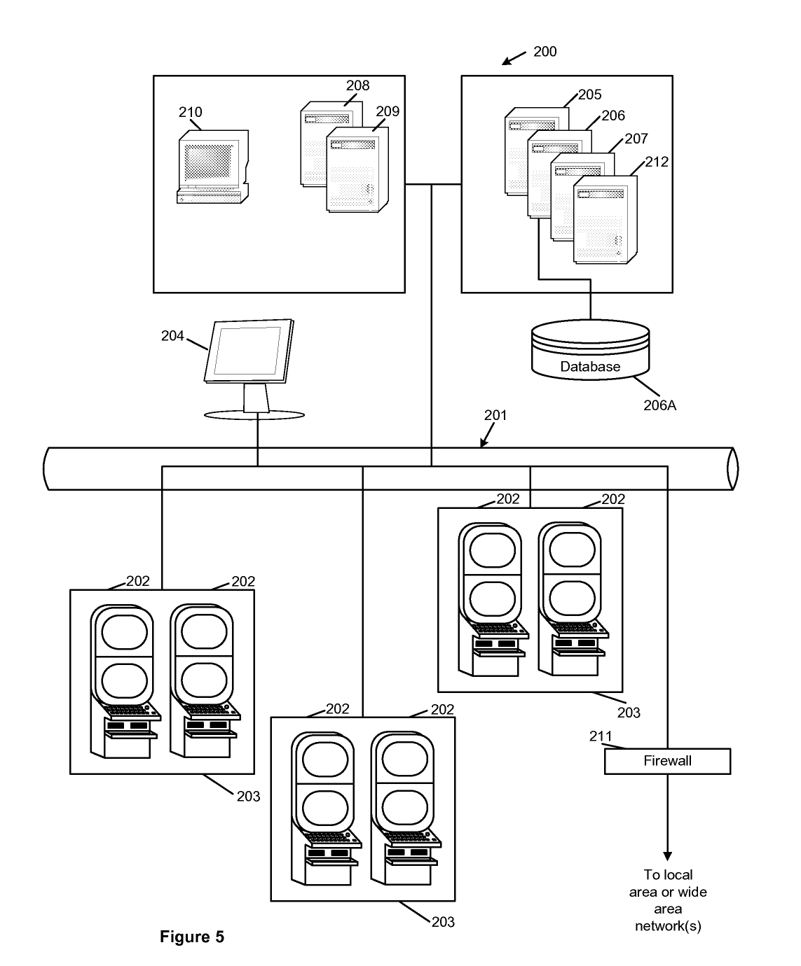

FIG. 5 shows a gaming system 200 in accordance with an alternative embodiment. The gaming system 200 includes a network 201, which for example may be an Ethernet network. Gaming machines 202, shown arranged in three banks 203 of two gaming machines 202 in FIG. 5, are connected to the network 201. The gaming machines 202 provide a player operable interface and may be the same as the gaming machines 10,100 shown in FIGS. 2 and 3, or may have simplified functionality depending on the rules, guidelines, preferences, and/or requirements for implementing game play. While banks 203 of two gaming machines are illustrated in FIG. 5, banks of one, three or more gaming machines are also envisaged.

One or more displays 204 may also be connected to the network 201. For example, the displays 204 may be associated with one or more banks 203 of gaming machines. The displays 204 may be used to display representations associated with game play on the gaming machines 202, and/or used to display other representations, for example promotional or informational material.

In a thick client embodiment, game server 205 implements part of the game played by a player using a gaming machine 202 and the gaming machine 202 implements part of the game. With this embodiment, as both the game server and the gaming device implement part of the game, they collectively provide a game controller. A database management server 206 may manage storage of game programs and associated data for downloading or access by the gaming devices 202 in a database 206A. Typically, if the gaming system enables players to participate in a Jackpot game, a Jackpot server 207 will be provided to perform accounting functions for the Jackpot game. A loyalty program server 212 may also be provided.

In a thin client embodiment, game server 205 implements most or all of the game played by a player using a gaming machine 202 and the gaming machine 202 essentially provides only the player interface. With this embodiment, the game server 205 provides the game controller. The gaming machine will receive player instructions, pass these to the game server which will process them and return game play outcomes to the gaming machine for display. In a thin client embodiment, the gaming machines could be computer terminals, e.g. PCs running software that provides a player interface operable using standard computer input and output components. Other client/server configurations are possible, and further details of a client/server architecture can be found in WO 2006/052213 and PCT/SE2006/000559, the disclosures of which are incorporated herein by reference.

Servers are also typically provided to assist in the administration of the gaming network 200, including for example a gaming floor management server 208, and a licensing server 209 to monitor the use of licenses relating to particular games. An administrator terminal 210 is provided to allow an administrator to run the network 201 and the devices connected to the network.

The gaming system 200 may communicate with other gaming systems, other local networks, for example a corporate network, and/or a wide area network such as the Internet, for example through a firewall 211.

Persons skilled in the art will appreciate that in accordance with known techniques, functionality at the server side of the network may be distributed over a plurality of different computers. For example, elements may be run as a single “engine” on one server or a separate server may be provided. For example, the game server 205 could run a random generator engine. Alternatively, a separate random number generator server could be provided. Further, persons skilled in the art will appreciate that a plurality of game servers could be provided to run different games or a single game server may run a plurality of different games based on the terminals.

### Further Detail of Gaming System

The player operates the game play mechanism 56 to specify a wager and hence the win entitlement which will be evaluated for this play of the game and initiates a play of the game. Persons skilled in the art will appreciate that a player's win entitlement will vary from game to game dependent on player selections. In most spinning reel games, it is typical for the player's entitlement to be affected by the amount they wager and selections they make (i.e. the nature of the wager). For example, a player's win entitlement may be based on how many lines they play in each game—e.g. a minimum of one line up to the maximum number of lines allowed by the game (noting that not all permutations of win lines may be available for selection) and how much they wager per line. Such win lines are typically formed by a combination of symbol display positions, one from each reel, the symbol display positions being located relative to one another such that they form a line.

In many games, the player's win entitlement is not strictly limited to the lines they have selected, for example, “scatter” pays are awarded independently of a player's selection of pay lines and are an inherent part of the win entitlement.

Persons skilled in the art will appreciate that in other embodiments, the player may obtain a win entitlement by selecting a number of reels to play and an amount to wager per reel. Such games are marketed under the trade name “Reel Power” by Aristocrat Leisure Industries Pty Ltd. The selection of the reel means that each displayed symbol of the reel can be substituted for a symbol at one or more designated display positions. In other words, all symbols displayed at symbol display positions corresponding to a selected reel can be used to form symbol combinations with symbols displayed at a designated, symbol display positions of the other reels. For example, if there are five reels and three symbol display positions for each reel such that the symbol display positions include three rows of five symbol display positions, the symbols displayed in the centre row are used for non-selected reels. As a result, the total number of ways to win is determined by multiplying the number of active display positions of each reel, the active display positions being all display positions of each selected reel and the designated display position of the non-selected reels. As a result for five reels and fifteen display positions there are 243 ways to win.

In other embodiments a player win entitlement may be affected by purchasing access to particular pay tables—e.g. a first bet amount entitles the player to wins including cherries and a second amount entitles them to wins including plums.

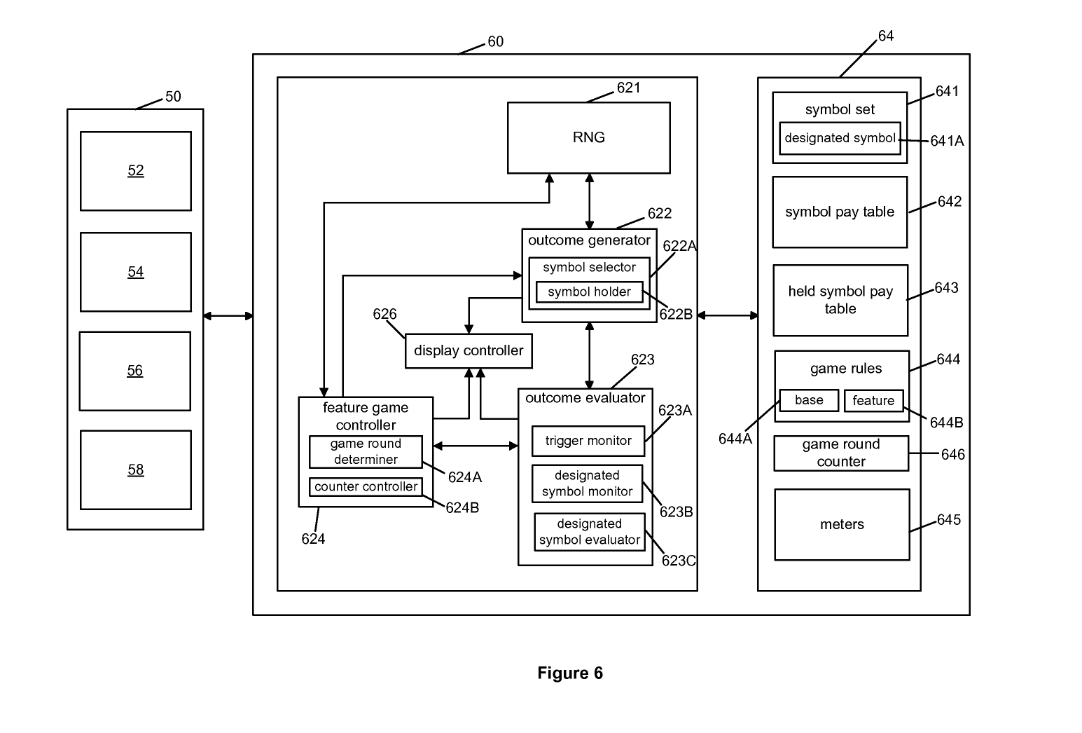

In FIG. 6, the processor 62 of game controller 60 is shown implementing a number of modules based on program code and data stored in memory 64. Persons skilled in the art will appreciate that one or more of the modules could be implemented in some other way, for example by a dedicated circuit.

These modules include the outcome generator 622 which operates in response to the player's operation of game play mechanism 56 to place a wager and initiate a play of the game and generates a game outcome which will then be evaluated by award evaluator 623. A symbol selector 622A operates to select symbols from a set of symbols specified by symbol data 641 using random number generator 621. The selected symbols are advised to the display controller 624 which causes them to be displayed on display 54 at a set of display positions.

In the embodiment, the symbol selector 622A selects symbols for display from a plurality of symbol sets corresponding to respective ones of a plurality of spinning reels. The symbol sets 641 specify a sequence of symbols for each reel such that the symbol selector 622A can select all of the symbols by selecting a stopping position in the sequence. In one example, three symbols of each of five reels may be displayed such that symbols are displayed at fifteen display positions on display 54. It is known to use a probability table stored in memory 64 to vary the odds of a particular stop position being selected. Other techniques can be used to control the odds of particular outcomes occurring to thereby control the return to player of the game.

During each play of the game, the outcome evaluator 623 evaluates the selected symbols relative to symbol pay table 642. The symbol pay table 642 defines what awards in credits will be made to the player for wins which correspond to the player's win entitlement.

As indicated above, the symbol set 641 includes designated symbols 641A which will satisfy a trigger condition if they occur. Accordingly, during each play of the game, a trigger monitor 623A of the outcome evaluator 623 determines whether there are sufficient designated symbols to lead to the feature game being triggered. In one example, 3, 4 or 5 of the designated symbol will result in a trigger. FIG. 6 also shows that the game rules may vary 644 from the base game to the feature game. For example, the base rules may specify that a particular symbol acts as a WILD symbol that substitutes for other symbols whereas the feature game may specify an additional symbol acts as a substitute symbol as indicated by feature game 644B.

In the embodiment, once the trigger monitor 623A determines that a trigger condition has been met the outcome evaluator 623 causes the feature game controller 624 to commence action. The feature game controller 624 includes a game round determiner 624A. The game round determiner 624A conducts a random determination to select from a set of available numbers a number of game rounds to award for each trigger symbol. In one embodiment, the available number of game rounds is 1 or 2 but in another embodiment the available number of game rounds could be, for example, 0, 1, 2, 3 and 4. In the embodiment, each number is equally probable but it would be appreciated that in some embodiments one number may be weighted over another. Accordingly, for each designated symbol, the game round determiner 624A obtains a random number from random number generator 621 to determine which number of game rounds is to be awarded. E.g. if the random number generator outputs numbers between 0 and 1, a number from 0.01 to 0.50=1 free game and a number from 0.51 to 1.0=2 free games. In the embodiment, this number sets an initial number of game rounds. To this end, the feature game controller includes a counter controller 624B which sets the number of game rounds to be conducted based on the number determined by the game round determiner. For example, if there were three trigger symbols and the game round determiner 624A determined respectively that 2, 2 and 1 game rounds should be conducted based on each trigger symbol, the total number of game rounds is initially set at 5 game rounds.

After the initial number of game rounds has been determined, the feature game controller 624 causes outcome generator 622 to generate a first game round. In this respect, the symbol selector includes a symbol holder 622B which holds each of the designated symbols at the position at which they occurred during the triggering game. The symbol selector 622A then selects further symbols for display by selecting new positions for each of the reels to stop. In the embodiment, the reels specified by the symbol set 641 for use in the feature game are the same as in the base game. However, persons skilled in the art will appreciate that as is known in some other games, the reel sets may be modified, for example by adding or substituting symbols for use in the feature game. Accordingly, it will be understood that where symbols are held, symbols are selected for each position other than where the held symbol is displayed on display 54. That is, that each held symbol supplants the symbol which would have been selected for that position.

In each game round of the feature game, the outcome evaluator 623 evaluates the selected symbols based on the symbol pay table 642 but further determines whether any other designated symbols have occurred with designated symbol monitor 623B. Any designated symbols are advised to the counter controller 624B as the counter controller 624B is arranged only to decrease the number of remaining game rounds upon no designated symbols occurring in a specific game round. That is, each time a designated symbol is monitored by the designated symbol monitor 623B the counter controller extends the series of game rounds by maintaining the counter at the same value. In the embodiment, the counter is displayed above the reel so that the player can see how many game rounds remain.

It will be appreciated that the number of designated symbols may increase during the game rounds. Once the counter controller 624B determines that the last game round of the feature game has been conducted (i.e. the game round counter 646 has reduced to 0 by the counter controller), it causes the designated symbol evaluator 623C to conduct an evaluation of the final display of designated symbols based on held symbol pay table 643 to determine an award to make. Pay table 643 specifies different awards in credits based on the number of designated symbols which have occurred. In one example, the pay table 643 is as follows:

| Symbols | Credit Prize |
|---|---|
| 20 | 1000 |
| 19 | 1000 |
| 18 | 1000 |
| 17 | 1000 |
| 16 | 80 |
| 15 | 40 |
| 14 | 25 |
| 13 | 20 |
| 12 | 16 |
| 11 | 12 |
| 10 | 10 |
| 9 | 8 |
| 8 | 7 |
| 7 | 6 |
| 6 | 5 |
| 5 | 4 |
| 4 | 3 |
| 3 | 2 |
| 2 | 1 |

It will be appreciated from the above example, that in the example a feature can be triggered with 2, 3, 4, or 5 designated symbols and that there are 5 reels each having 4 symbols that are selected during each play of the game. The awards made to the player are added to a win meter of meter 645 and then transferred to a credit meter upon the player initiating a further play of the game and/or deciding to cash out.

In some embodiments, an eligibility criteria may be applied for the player to be eligible for the feature game, for example that the player has made a certain sized wager, made an ante bet, selected all win lines, played sufficient games, or the player is a member of a loyalty program.

Persons skilled in the art will appreciate from the above that the base game is a part of the game which is carried out each time the player makes a wager, typically irrespective of the wager, whereas the feature game will only be carried out occasionally for example if a condition is met such as a trigger occurring or if an ante bet is placed (depending on the specific embodiment).

Persons skilled in the art will appreciate that a feature game involves some additional element of game play which usually only occurs when a trigger condition is met. Types of feature games include: those where a series of free game events are awarded such as free games or re-spins (where some reels are held while others are re-spun); games where the symbols on the reel are changed; and “second screen” games where game play is totally different to the base game, for example where the player makes selections in a “pick a box type” game. In the above embodiment, the game events that are awarded based on the trigger symbols are game rounds. Persons skilled in the art will appreciate that in other embodiments, the awarded game events will correspond to the feature game, such as a number of picks in a pick.

While the above embodiment describes a trigger which leads to an advantageous determination of an initial number of game rounds, in other embodiments an initial number of game rounds may be awarded in some different manner, for example the number of game rounds may be fixed. In such embodiments, the trigger event may take a different form. For example, the trigger event may be caused by another connected system, based on turnover, based on a random evaluation, etc.

In spinning reel game, a game round involves at least one of the reels being “spun”—e.g. new symbols of the reels are selected for display at least some of the display positions and the reel is virtually spun to a stop. Persons skilled in the art will appreciate that there may be more than one game round in a play of a gaming machine such as is the case when a series of free spins is awarded. The outcome of a game round may be no win, a win (for example from a winning combination of symbols), a contribution towards a win accrued over a plurality of game rounds, a trigger condition occurring etc. Typically, a win will result in some form of award being made such as an award of credits. Such an award may never actually be physically received by a player. For example, many gaming systems provide a player with a double or nothing gamble feature, where the player can double or forfeit their credits before commencing another play of the game or cashing out. Further, as credits are fungible, once credits have been added to the credit meter it is not possible to distinguish between credits which exist because the player has input cash or the like and credits resulting from an award.

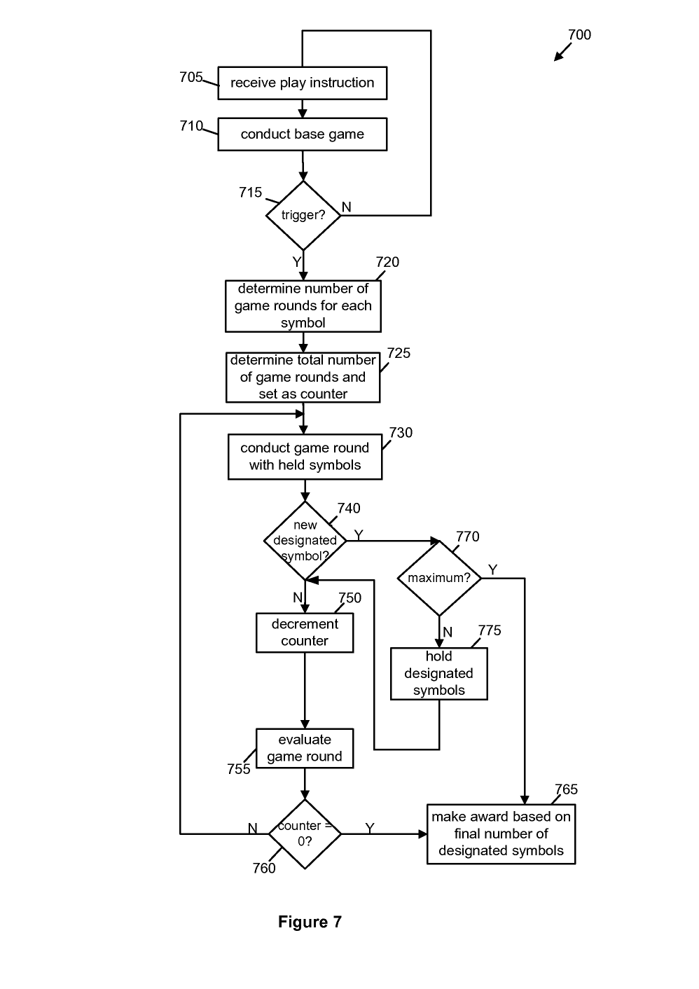

FIG. 7 shows a method 700 of an embodiment of the invention. The method involves receiving a play instruction 705, conducting a base game 710 and determining whether a trigger has occurred 715. Upon the trigger occurring, the method involves separately determining a number of game rounds for each symbol in the trigger 720 to produce a total number of game rounds that is set as the counter 725 for the game rounds.

The method then involves conducting a series of game rounds with held symbols. Each game round involves determining if a new designated symbol appears. When no new designated symbol appears, the counter is decremented 750 and 750 and the game round is evaluated 755. Upon a new designated symbol appearing it is determined whether a maximum number of symbols has occurred 770. If not, the designated symbols are held 775, the counter is decremented 750 and the game round is evaluated 755. The method continues until ether the counter reaches zero 760 or a maximum number of designated symbols is reached 770 after which an award is made based on the final number of designated symbols 765.

Further aspects of the method will be apparent from the above description of the system. It will be appreciated that at least part of the method will be implemented electronically, for example, digitally by a processor executing program code such as in the above description of a game controller. In this respect, in the above description certain steps are described as being carried out by a processor of a gaming system, it will be appreciated that such steps will often involve a number of sub-steps to be carried out for the steps to be implemented electronically, for example due to hardware or programming limitations. For example, to carry out a step such as evaluating, determining or selecting, a processor may need to compute several values and compare those values.

As indicated above, the method may be embodied in program code. The program code could be supplied in a number of ways, for example on a tangible computer readable storage medium, such as a disc or a memory device, e.g. an EEPROM, (for example, that could replace part of memory 103) or as a data signal (for example, by transmitting it from a server). Further different parts of the program code can be executed by different devices, for example in a client server relationship. Persons skilled in the art, will appreciate that program code provides a series of instructions executable by the processor.

It will be understood to persons skilled in the art of the invention that many modifications may be made without departing from the spirit and scope of the invention, in particular it will be apparent that certain features of embodiments of the invention can be employed to form further embodiments.

It is to be understood that, if any prior art is referred to herein, such reference does not constitute an admission that the prior art forms a part of the common general knowledge in the art in any country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

Embodiments within the scope of the present invention include program products comprising machine-readable media for carrying or having machine-executable instructions or data structures stored thereon. Such machine-readable media can be any available media that can be accessed by a general purpose or special purpose computer or other machine with a processor. By way of example, such machine-readable media may comprise RAM, ROM, PROM, EPROM, EEPROM, Flash, CD-ROM, Blu-Ray, and/or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

1. An electronic method of gaming comprising:
conducting a base game portion of a game by selecting a plurality of symbols for display at a plurality of symbol positions on a display;
evaluating the selected symbols to determine whether a trigger condition has been met for a feature game portion of the game to be conducted, the trigger condition comprising the occurrence of a defined combination of trigger symbols amongst the selected symbols;
upon the trigger condition being met, independently determining, for each trigger symbol of the combination of trigger symbols, a number of game events to be awarded from at least two different numbers of game events to thereby determine a total number of game events to be awarded for the feature game portion of the game; and
conducting the feature game based on the total number of game events awarded.

2. A method as claimed in claim 1, wherein determining the number of game events comprises selecting a number from a set of possible numbers of game events for each individual trigger symbol.

3. A method as claimed in claim 1, wherein each game event comprises a game round to be conducted in the feature game.

4. A method as claimed in claim 3, comprising adding to the number of game rounds conducted in the feature game in response to an extension condition being met in respect of a game round in the feature game.

5. A method as claimed in claim 4, wherein the extension condition comprises an improvement to a winning combination in the game round.

6. A gaming system comprising:
a display;
a symbol selector arranged to selecting a plurality of symbols for display at a plurality of symbol positions on the display as part of a base game portion of a game conducted by the gaming system;
a trigger monitor arranged to evaluating the selected symbols to determine whether a trigger condition has been met for a feature game portion of the game to be conducted, the trigger condition comprising the occurrence of a defined combination of trigger symbols amongst the selected symbols; and
a game round determiner arranged to independently determine for each trigger symbol of a combination of trigger symbols evaluated as meeting the trigger condition, a number of game events to be awarded from at least two different numbers of game events to thereby determine a total number of game events to be awarded for the feature game portion of the game,
the gaming system arranged to conduct the feature game based on the total number of game events awarded.

7. A gaming system as claimed in claim 6, wherein the game round determiner determines the number of game events by selecting a number from a set of possible numbers of game events for each individual trigger symbol.

8. A gaming system as claimed in claim 7, wherein each game event comprises a game round to be conducted in the feature game.

9. A gaming system as claimed in claim 8, wherein the gaming system is arranged to add to the number of game rounds conducted in the feature game in response to an extension condition being met in respect of a game round in the feature game.

10. A gaming system as claimed in claim 5, wherein the extension condition comprises an improvement to a winning combination in the game round.

11. A game controller for a gaming system, the game controller arranged to:
conduct a base game portion of a game by selecting a plurality of symbols for display at a plurality of symbol positions on a display;
evaluate the selected symbols to determine whether a trigger condition has been met for a feature game portion of the game to be conducted, the trigger condition comprising the occurrence of a defined combination of trigger symbols amongst the selected symbols;
upon the trigger condition being met, independently determine, for each trigger symbol of the combination of trigger symbols, a number of game events to be awarded from at least two different numbers of game events to thereby determine a total number of game events to be awarded for the feature game portion of the game; and
conduct the feature game based on the total number of game events awarded.

12. A game controller as claimed in claim 11, arranged to determine the number of game events by selecting a number from a set of possible numbers of game events for each individual trigger symbol.

13. A game controller as claimed in claim 11, wherein each game event comprises a game round to be conducted in the feature game.

14. A game controller as claimed in claim 13, arranged to add to the number of game rounds conducted in the feature game in response to an extension condition being met in respect of a game round in the feature game.

15. A game controller as claimed in claim 14, wherein the extension condition comprises an improvement to a winning combination in the game round.

16. An electronic method of gaming comprising:
initiating a series of game rounds based on initial designated symbols and an initial number of game rounds to be conducted with each designated symbol displayed at a symbol display position of a plurality of symbol display positions at which the designated symbol is to be held throughout the series of game rounds;
conducting each game round by selecting symbols for display at symbol display positions other than symbol display positions at which designated symbols are held;
upon one or more designated symbols being selected in a game round of the series, extending the series of game rounds by at least one game round and adding the one or more designated symbols to the designated symbols held at symbol display positions in subsequent game rounds; and
making an award at the conclusion of the series of game rounds based on the displayed designated symbols.

17. A method as claimed in claim 16, comprising extending the series of game rounds by one game.

18. A method as claimed in claim 16, comprising terminating the series of game rounds upon a maximum number of designated symbols being reached.

19. A gaming system comprising:
a display; and
a game controller arranged to:
initiate a series of game rounds based on initial designated symbols and an initial number of game rounds to be conducted with each designated symbol displayed at a symbol display position of a plurality of symbol display positions at which the designated symbol is to be held throughout the series of game rounds;
conduct each game round by selecting symbols for display at symbol display positions other than symbol display positions at which designated symbols are held;
upon one or more designated symbols being selected in a game round of the series, extend the series of game rounds by at least one game round and adding the one or more designated symbols to the designated symbols held at symbol display positions in subsequent game rounds; and
make an award at the conclusion of the series of game rounds based on the displayed designated symbols.

20. A gaming system as claimed in claim 19, arranged to extend the series of game rounds by one game.

21. A gaming system as claimed in claim 19, arranged to terminate the series of game rounds upon a maximum number of designated symbols being reached.

22. A game controller for a gaming system, the game controller arranged to:
initiate a series of game rounds based on initial designated symbols and an initial number of game rounds to be conducted with each designated symbol displayed at a symbol display position of a plurality of symbol display positions at which the designated symbol is to be held throughout the series of game rounds;
conduct each game round by selecting symbols for display at symbol display positions other than symbol display positions at which designated symbols are held;
upon one or more designated symbols being selected in a game round of the series, extend the series of game rounds by at least one game round and adding the one or more designated symbols to the designated symbols held at symbol display positions in subsequent game rounds; and
make an award at the conclusion of the series of game rounds based on the displayed designated symbols.

23. A game controller as claimed in claim 22, arranged to extend the series of game rounds by one game.

24. A game controller as claimed in claim 22, arranged to terminate the series of game rounds upon a maximum number of designated symbols being reached.

25. A tangible computer readable medium comprising computer program code which, when executed by a processor, implements a method, the method comprising:
conducting a base game portion of a game by selecting a plurality of symbols for display at a plurality of symbol positions on a display;
evaluating the selected symbols to determine whether a trigger condition has been met for a feature game portion of the game to be conducted, the trigger condition comprising the occurrence of a defined combination of trigger symbols amongst the selected symbols;
upon the trigger condition being met, independently determining, for each trigger symbol of the combination of trigger symbols, a number of game events to be awarded from at least two different numbers of game events to thereby determine a total number of game events to be awarded for the feature game portion of the game; and
conducting the feature game based on the total number of game events awarded.

26. A tangible computer readable medium comprising computer program code which, when executed by a processor, implements a method, the method comprising:
initiating a series of game rounds based on initial designated symbols and an initial number of game rounds to be conducted with each designated symbol displayed at a symbol display position of a plurality of symbol display positions at which the designated symbol is to be held throughout the series of game rounds;
conducting each game round by selecting symbols for display at symbol display positions other than symbol display positions at which designated symbols are held;
upon one or more designated symbols being selected in a game round of the series, extending the series of game rounds by at least one game round and adding the one or more designated symbols to the designated symbols held at symbol display positions in subsequent game rounds; and
making an award at the conclusion of the series of game rounds based on the displayed designated symbols.
